(19) United States
(12) Patent Application Publication
(10) Pub. No.: US 2017/0024369 A1
(43) Pub. Date: Jan. 26, 2017

(54) Event Tagging Systems And Methods

(71) Applicant: Ford Global Technologies, LLC, Dearborn, MI (US)

(72) Inventors: Jamel Seagraves, Mountain View, CA (US); Chih-Wei Tang, Mountain View, CA (US); Sudipto Aich, Palo Alto, CA (US); Yonathan Redda, Sunnyvale, CA (US)

(21) Appl. No.: 14/808,760

(22) Filed: Jul. 24, 2015

(51) Int. Cl. G06F 17/24; H04W 4/02

(52) U.S. Cl. CPC G06F 17/241; H04W 4/02

(57) ABSTRACT

Example event tagging systems and methods are described. In one implementation, a system includes a button that can be activated by a user in response to an event. An event tagging manager identifies user-activation of the button and determines a geographic location of the button and a time of button activation. The event tagging manager also stores the geographic location and the time of button activation. An annotation manager is capable of accessing the stored geographic location and time associated with the event, and supports user-annotation of the event.

### TECHNICAL FIELD

The present disclosure relates to systems and methods that allow a user to tag events and annotate the events at a future time.

### BACKGROUND

In many areas, such as densely populated cities with heavy traffic, alternative modes of transportation are popular. For example, bikes and e-bikes (electric bicycles) are commonly used in densely populated areas. Experienced users of bikes, e-bikes, and other modes of transportation may select a route based on prior knowledge of the roads (e.g., road conditions or current road construction), expected car traffic, number of pedestrians, and road safety (e.g., dangerous intersections or locations of potential accidents).

Users of bikes, e-bikes, and other modes of transportation may observe multiple events when riding or driving on various roads. Although users may remember some of the events, they may have difficulty remembering the exact location of each event and the time that the event occurred. Further, most users apply knowledge of their own past events when planning routes in the future.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 depicts an example embodiment of a system for tagging and annotating events.

FIG. 2 is a block diagram illustrating an embodiment of an event tagging manager.

FIG. 3 depicts another example embodiment of a system for tagging events.

FIGS. 4A and 4B depict example user interfaces that allow a user to annotate one or more tagged events.

FIGS. 5A and 5B depict example user interfaces that allow a user to annotate one or more images associated with one or more tagged events.

FIG. 6 depicts an example embodiment of a system for sharing event information with a social community.

FIG. 7 is a flow diagram depicting an embodiment of a method for tagging an event.

FIG. 8 is a flow diagram depicting an embodiment of a method for annotating a tagged event and sharing event information with a social community.

FIG. 9 is a block diagram depicting an example computing device.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The event tagging systems and methods discussed herein allows users to tag certain events quickly while riding a bike or using another mode of transportation. The terms “bike” and “bicycle” are used interchangeably herein. The user can easily activate a button, which tags an event (that is observed by the user), without interrupting their ride or distracting their focus from the current driving situation. Particular embodiments provide a button that can be activated by a user in response to an event, such as bad road conditions, street lighting problems, potential accidents, and other potentially dangerous situations for bike riders, runners, pedestrians, and the like. An event tagging manager detects user-activation of the button and determines a geographic location of the button as well as the date and time the button was activated. The geographic location, date, and time information is stored as an event record. At a later time, a computing device accesses the event record and allows the user to annotate the event (e.g., by adding a textual description of the event and/or editing an image associated with the event).

As used herein, “events” refer to any activity, condition or situation identified by a user. Example events include, but are not limited to, road conditions (e.g., potholes, obstacles, road construction, poor street lighting, bad bike lane markings (or lack of bike lane markings), heavy vehicle traffic, heavy pedestrian traffic, dangerous intersections, accidents, potential accidents, and the like.

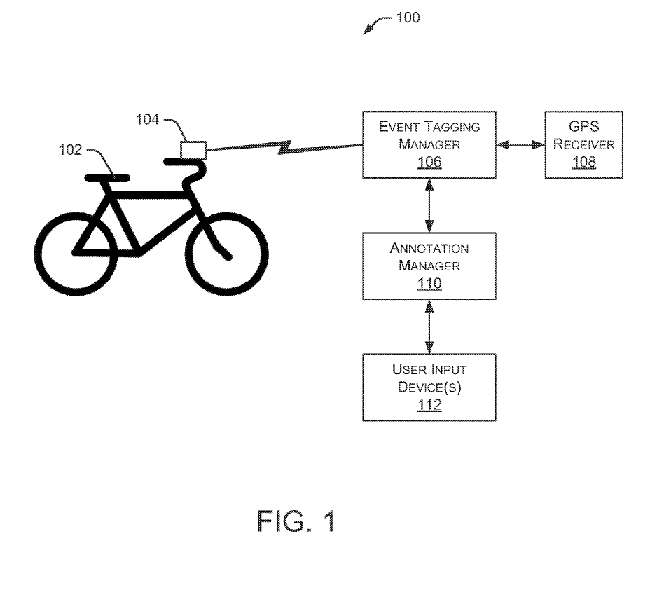

FIG. 1 depicts an example embodiment of a system 100 for tagging and annotating events. System 100 includes a bicycle or electric bicycle (e-bike) 102 and a button 104 mounted on bicycle 102. Although specific examples of the event tagging systems and methods discussed herein include a bicycle, alternate embodiments are used with any type of vehicle, such as motorcycles, scooters, cars, trucks, buses, and the like. Additionally, specific embodiments may be used by pedestrians, runners, and so forth. In some embodiments, button 104 is a mechanical button (or switch) mounted on a handlebar or other easily accessible area of bicycle 102. In other embodiments, button 104 is any type of device capable of activation by a user to identify a particular event. Alternate embodiments of button 104 include any type of human interface device, such as sensors, touch sensors, and the like.

Button 104 is positioned such that the rider of bicycle 102 can easily activate the button without diverting their attention from the road and potential obstacles in their riding path. In some embodiments, a particular bicycle 102 may contain multiple buttons 104 (e.g., one mounted on the left side of the handlebar and a second button mounted on the right side of the handlebar). The multiple buttons 104 may be redundant (i.e., each button tags events in the same manner) or may tag different types of events. For example, a first button 104 mounted on the left side of the handlebar may tag road condition events (e.g., potholes, poor street lighting or bad bike lane markings) and a second button 104 mounted on the right side of the handlebar may tag traffic/safety events (e.g., dangerous intersections, heavy pedestrian traffic or potential accidents).

Button 104 communicates with an event tagging manager 106 via a wired or a wireless communication link. In some embodiments, event tagging manager 106 is mounted to bicycle 102 as a separate device or incorporated into a housing that also contains button 104. In other embodiments, event tagging manager 106 is located near button 104 such that event tagging manager 106 can communicate wirelessly with button 104. For example, event tagging manager 106 may be carried by the user in a pocket, backpack, purse, or the like. In specific implementations, event tagging manager 106 is invoked by a mobile device mounted to bicycle 102 or located near bicycle 102. In particular embodiments, button 104 communicates wirelessly with event tagging manager 106 using the Bluetooth® wireless communication system. In alternate embodiments, any communication system is used to communicate signals between button 104 and event tagging manager 106.

A GPS (Global Positioning System) receiver 108 is coupled to event tagging manager 106 via a wired or wireless communication link. Upon detection of a user-activation of button 104, event tagging manager 106 determines the current geographic location based on information received from GPS receiver 108. The geographic location data from GPS receiver 108 is used to tag the event's location for future reference when the user annotates the tagged event. Additionally, event tagging manager 106 tags the event with the date and time that button 104 was activated. In some implementations, event tagging manager 106 may also tag the event with a bike identifier that identifies the particular bike on which the activated button 104 is mounted. Although GPS receiver 108 is shown as a separate component, in some embodiments, GPS receiver 108 is incorporated into event tagging manager 106.

An annotation manager 110 is coupled to event tagging manager 106 and allows a user to add annotations to tagged events at a later time. Thus, while riding bicycle 102, the user activates button 104 to tag a particular event. Then, at a later time, the user is reminded of the tagged events and given an opportunity to add comments, annotate images, and provide other details regarding the event. As discussed herein, the annotated event information can be shared with one or more other users in, for example, a social community. One or more user input devices 112 are coupled to annotation manager 110 and allow the user to enter text, images, and other annotation information. Example user input devices 112 include keyboards, keypads, pointing devices, and the like. In particular embodiments, annotation manager 110 and user input devices 112 are associated with a separate computing device capable of communicating with event tagging manager 106. The computing device may be any type of device including, for example, a laptop computer, a desktop computer, a tablet computer, a mobile computing device, and the like. The user annotation process is discussed in greater detail below.

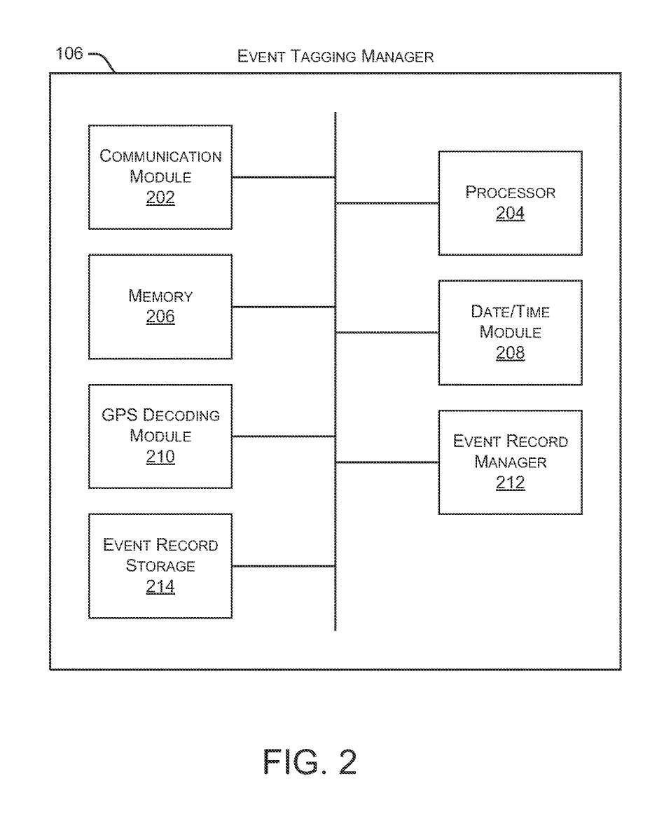

FIG. 2 is a block diagram illustrating an embodiment of event tagging manager 106. As shown in FIG. 2, event tagging manager 106 includes a communication module 202, a processor 204, and a memory 206. Communication module 202 allows event tagging manager 106 to communicate with other systems, such as a button 104, GPS receiver 108, annotation manager 110, other computing devices, and the like. Processor 204 executes various instructions to implement the functionality provided by event tagging manager 106. Memory 206 stores these instructions as well as other data used by processor 204 and other modules contained in event tagging manager 106.

Additionally, event tagging manager 106 includes a date/time module 208 that maintains (or determines) a current date and time used to tag events identified by a user. A GPS decoding module 210 decodes data received from GPS receiver 108 to identify a specific geographic location associated with a tagged event. As mentioned above, in alternate embodiments, GPS receiver 108 may be integrated into event tagging manager 106.

Event tagging manager 106 also includes a an event record manager 212, which creates and accesses event records associated with a user-identified event. An example event record includes information related to a specific event, such as date, time, geographic location, and the like. Event record manager 212 generates event records based on received information, and stores the event records in an event record storage 214. Additionally, event record manager 212 can access event records from storage 214 as part of the user annotation process. As discussed herein, the event records may be updated after receiving one or more user annotations.

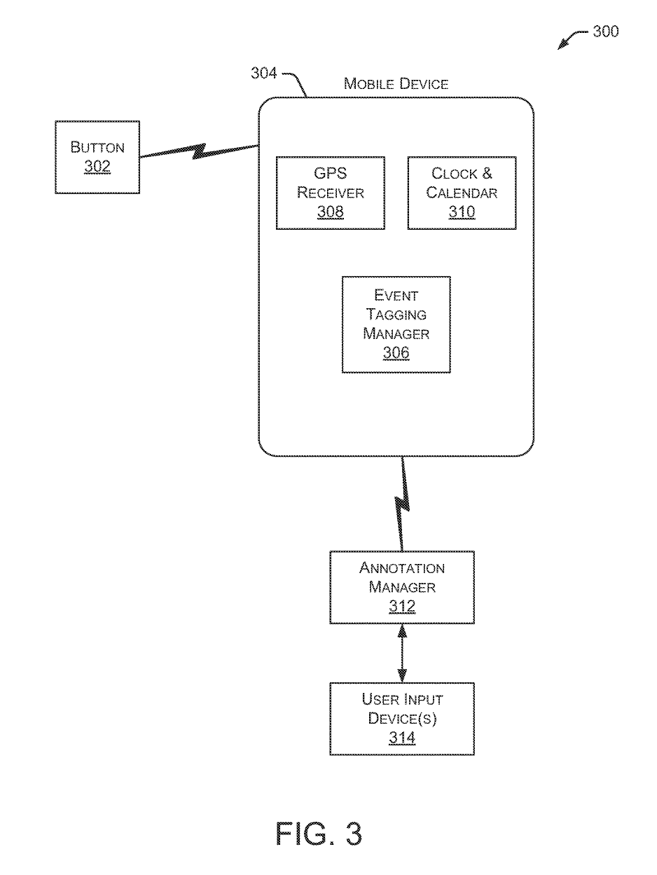

FIG. 3 depicts another example embodiment of a system 300 for tagging events. A button 302 is activated by a user to identify a particular event. As discussed above with respect to FIG. 1, button 302 may be mounted to a bicycle handlebar or other location that is easily accessible by a user while riding the bicycle. A mobile device 304 communicates with button 302 to receive an indication of user-activation of button 302. Mobile device is any type of portable computing device, such as a smartphone, tablet computer, portable entertainment system, and the like. In the embodiment of FIG. 3, button 302 communicates wirelessly with mobile device 304. Mobile device 304 includes an event tagging manager 306, a GPS receiver 308, and a clock and calendar module 310. As discussed above, event tagging manager 306 receives an indication that a user activated button 302. In response to the user-activation of button 302, event tagging manager 306 obtains GPS location information as well as date and time information to create an event record that represents the tagged event.

An annotation manager 312 is coupled to event tagging manager 306 and allows a user to annotate one or more events. One or more user input devices 314 are used to provide annotations to the events. Although annotation manager 312 and user input devices 314 are shown as separate components, in alternate embodiments, annotation manager 312 and/or user input devices 314 may be incorporated into mobile device 304. For example, annotation manager 312 may be invoked by mobile device 304 and at least one of the user input devices 314 is a touchscreen associated with mobile device 304.

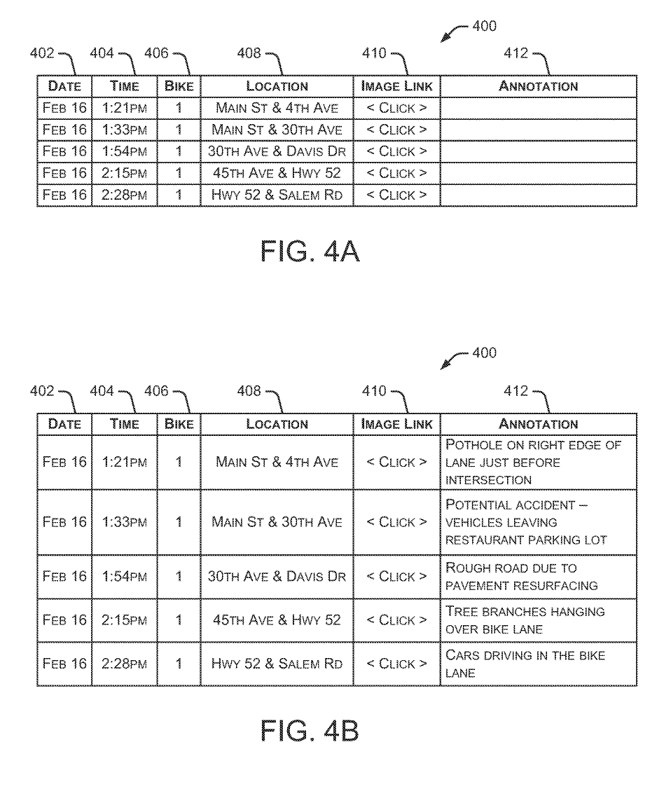

FIGS. 4A and 4B depict example user interfaces that allow a user to annotate one or more tagged events. FIG. 4A illustrates a user interface 400 displaying a table that includes a listing of five tagged events (each row of the table represents one tagged event). For each tagged event, the table identifies the date 402 and time 404 the event was tagged, a bike (or other vehicle) 406 that tagged the event, a geographic location 408 where the event was tagged, and an image link 410 associated with an image of the geographic location where the event was tagged. In some embodiments, image link 410 is a link to a website that displays an image of the geographic location 408 based on, for example, the GPS coordinates associated with the event. An online mapping service can use these GPS coordinates to identify an image (e.g., an overhead or satellite image) of the geographic location associated with the event. Clicking on image link 410 displays the image, which may refresh a user's memory regarding the event that occurred at that geographic location. An annotation field 412 is empty in FIG. 4A because the user has not yet provided any annotation information for the five tagged events.

FIG. 4B illustrates the same user interface 400, now displaying the table with user annotations 412 for each of the five tagged events. As shown, each event is annotated with information related to road safety, road condition, potential accident concerns, and so forth.

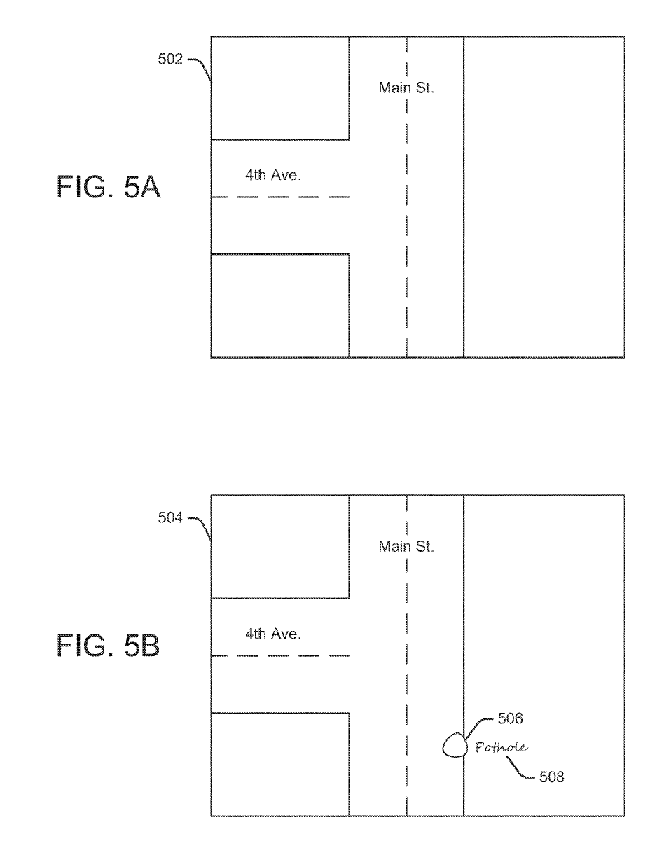

FIGS. 5A and 5B depict example user interfaces that allow a user to annotate one or more images associated with one or more tagged events. FIG. 5A illustrates an image 502 displaying a geographic location associated with a tagged event. As discussed above, image 502 may be accessed based on GPS coordinates associated with the event using a map service or other data source. Image 502 is associated with the first tagged event shown in user interface 400. As shown in FIG. 4B, the first tagged event is associated with a pothole in the road surface.

FIG. 5B illustrates an annotated image 504, which is an annotated version of image 502. In this example, image 504 includes two annotations: a graphical representation 506 of the location of the pothole and a text notation 508 indicating that graphical representation 506 is a pothole. A user can add annotations 506 and 508 using a text editor, graphic editor, drawing application or any other system that supports the annotation of images.

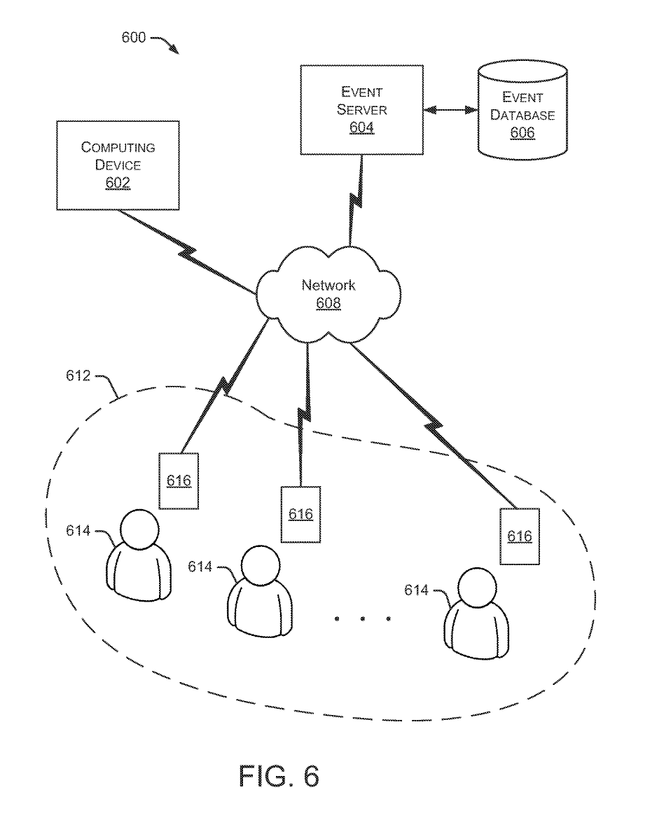

FIG. 6 depicts an example embodiment of a system 600 for sharing event information with a social community. System 600 includes a computing device 602 and an event server 604 coupled to a data communication network 608. Computing device 602 is any type of device capable of accessing data communication network 608 and communicating with other devices or systems. Data communication network 608 may be any type of network using any communication protocol. Further, data communication network 608 may be a combination of multiple different data communication networks. Event server 604 is coupled to an event database 606, which stores data (including user annotations) associated with multiple tagged events. Event server 604 communicates with various systems, such as event tagging managers and annotation managers, to receive tagged events and data associated with the tagged events.

Event server 604 also communicates with a social community 612 (also referred to as a social platform) that includes any number of members 614. In a particular implementation, social community 612 is a community of bicycle enthusiasts. Members 614 can access tagged event data using a computing device 616 (e.g., a mobile computing device) coupled to communicate with event server 604 via data communication network 608. For example, when a member 614 is planning a bicycle route, the member may consider tagged event data provided by other members to select an appropriate route. In some embodiments, event server 604 automatically notifies members 614 of new tagged event data, especially data associated with routes previously followed by the member. Members 614 of social community 612 can also communicate with one another regarding topics unrelated to event data.

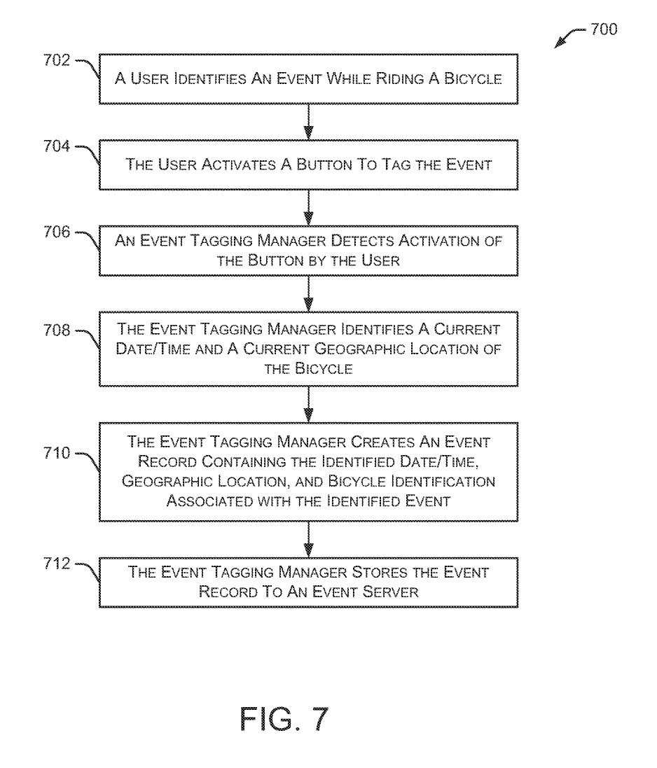

FIG. 7 is a flow diagram depicting an embodiment of a method 700 for tagging an event. Initially, a user identifies an event while riding a bicycle or other vehicle at 702. The user activates a button mounted on the bicycle to tag the event at 704. An event tagging manager detects activation of the button by the user at 706. The event tagging manager also identifies a current date/time and a current geographic location of the bicycle at 708. Method 700 continues as the event tagging manager creates an event record containing the identified date/time, geographic location, and a bicycle identification associated with the identified event at 710. The event tagging manager then stores the event record to an event server at 712. In alternate embodiments, the event tagging manager stores the event record to a different storage system or stores the event record within the event tagging manager.

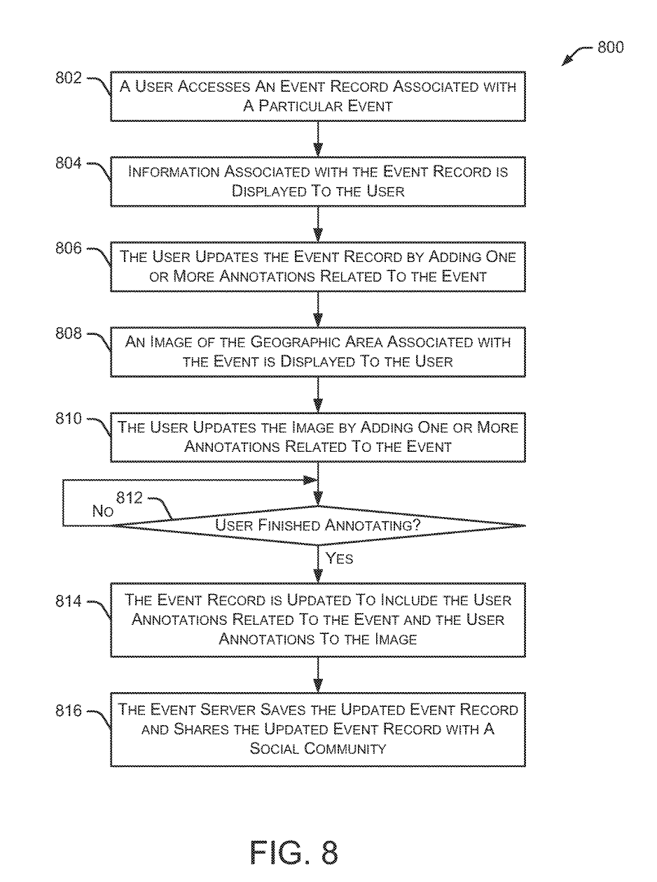

FIG. 8 is a flow diagram depicting an embodiment of a method 800 for annotating a tagged event and sharing event information with a social community. Initially, a user accesses an event record associated with a particular event at 802. For example, the event record may be accessed from an event server. Information associated with the event record is displayed to the user at 804. The user is able to update the event record by adding one or more annotations related to the event at 806. An image of the geographic area associated with the event is displayed to the user at 808. The user is able to update the image by adding one or more annotations related to the event at 810. The user may add any number of annotations to any number of events. When the user is finished adding annotations at 812, the event record is updated to include the user annotations related to the event and the user annotations to the image at 814. The event server then saves the updated event record and shares the updated event record with at least some members of a social community at 816.

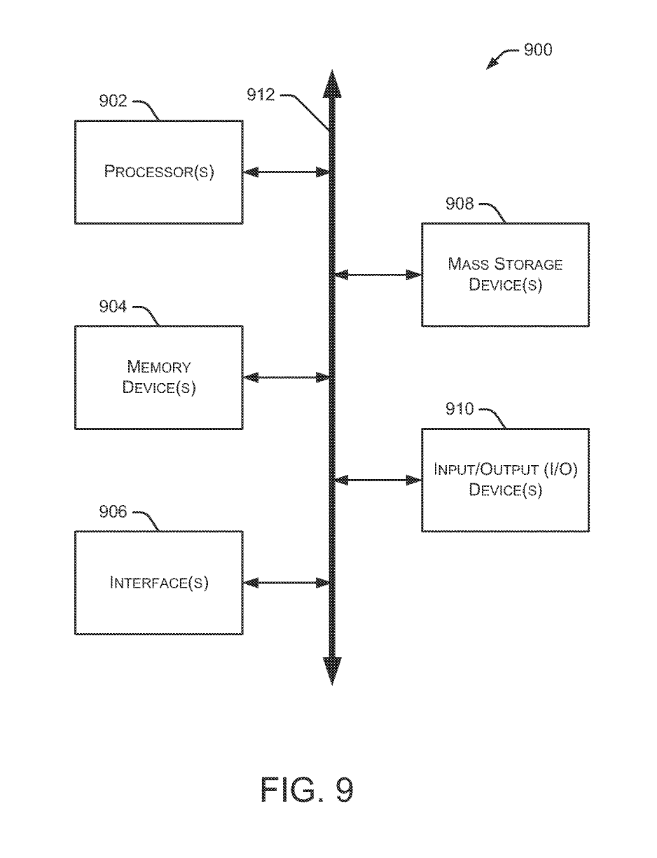

FIG. 9 is a block diagram depicting an example computing device 900. Computing device 900 may be used to perform various procedures, such as those discussed herein. Computing device 900 can function as a server, a client or any other computing entity. Computing device 900 can be any of a wide variety of computing devices, such as a desktop computer, a notebook computer, a server computer, a handheld computer, a tablet, and the like.

Computing device 900 includes one or more processor(s) 902, one or more memory device(s) 904, one or more interface(s) 906, one or more mass storage device(s) 908, and one or more Input/Output (I/O) device(s) 910, all of which are coupled to a bus 912. Processor(s) 902 include one or more processors or controllers that execute instructions stored in memory device(s) 904 and/or mass storage device(s) 908. Processor(s) 902 may also include various types of computer-readable media, such as cache memory.

Memory device(s) 904 include various computer-readable media, such as volatile memory (e.g., random access memory (RAM)) and/or nonvolatile memory (e.g., read-only memory (ROM)). Memory device(s) 904 may also include rewritable ROM, such as Flash memory.

Mass storage device(s) 908 include various computer readable media, such as magnetic tapes, magnetic disks, optical disks, solid state memory (e.g., Flash memory), and so forth. Various drives may also be included in mass storage device(s) 908 to enable reading from and/or writing to the various computer readable media. Mass storage device(s) 908 include removable media and/or non-removable media.

I/O device(s) 910 include various devices that allow data and/or other information to be input to or retrieved from computing device 900. Example I/O device(s) 910 include cursor control devices, keyboards, keypads, microphones, monitors or other display devices, speakers, printers, network interface cards, modems, lenses, CCDs or other image capture devices, and the like.

Interface(s) 906 include various interfaces that allow computing device 900 to interact with other systems, devices, or computing environments. Example interface(s) 906 include any number of different network interfaces, such as interfaces to local area networks (LANs), wide area networks (WANs), wireless networks, and the Internet.

Bus 912 allows processor(s) 902, memory device(s) 904, interface(s) 906, mass storage device(s) 908, and I/O device(s) 910 to communicate with one another, as well as other devices or components coupled to bus 912. Bus 912 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 900, and are executed by processor(s) 902. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. An apparatus comprising:
a button capable of user-activation responsive to an event;
an event tagging manager configured to identify user-activation of the button and determine a geographic location of the button and a time of button activation, and further configured to store the geographic location and the time of button activation; and
an annotation manager configured to access the stored geographic location and time associated with the event, and allow user-annotation of the event.

2. The apparatus of claim 1, wherein the event includes at least one of bad road conditions, obstacles in the road, road construction, poor street lighting, bad bike lane markings, missing bike lane markings, heavy vehicle traffic, heavy pedestrian traffic, dangerous intersections, accidents, and potential accidents.

3. The apparatus of claim 1, further comprising a GPS (Global Positioning System) receiver coupled to the event tagging manager and configured to determine the geographic location of the button when activated.

4. The apparatus of claim 1, wherein the event tagging manager includes a GPS (Global Positioning System) receiver configured to determine the geographic location of the event tagging manager when the button is activated.

5. The apparatus of claim 1, wherein the user-annotation of the event occurs at a time subsequent to the event.

6. The apparatus of claim 1, wherein the user-annotation of the event occurs at a geographic location different from the event location.

7. The apparatus of claim 1, wherein the button and the event tagging manager are mounted to a bicycle.

8. The apparatus of claim 1, wherein the event tagging manager is a mobile device located proximate a bicycle.

9. The apparatus of claim 1, wherein the button is a mechanical button disposed proximate the user's finger.

10. The apparatus of claim 1, wherein the button is a touch sensor disposed proximate the user's finger.

11. The apparatus of claim 1, wherein the event tagging manager is further configured to create an event record including the time of button activation, the geographic location at the time of button activation, and an identification of a bicycle on which the button is mounted.

12. A method comprising:
identifying a user activation of a button in response to an event;
identifying a date and time associated with activation of the button;
identifying a geographic location of the button at the time of activation;
creating an event record including the date, time, and geographic location;
storing the event record; and
at a subsequent time, accessing the stored event record and allowing the user to annotate the event record.

13. The method of claim 12, wherein allowing the user to annotate the event record includes adding at least one text annotation to the event record.

14. The method of claim 12, wherein allowing the user to annotate the event record includes adding at least one annotation to an image associated with the event record.

15. The method of claim 12, further comprising communicating the annotated event record to an event server that stores the annotated event record.

16. The method of claim 12, further comprising sharing the annotated event record with a plurality of members of a social community.

17. The method of claim 12, wherein the user annotation provides details associated with the event that were observed by the user at the time of the event.

18. An apparatus comprising:
a button configured to be activated by a user responsive to an event; and
a mobile device configured to identify user-activation of the button, wherein the mobile device includes an event tagging manager configured to identify user-activation of the button and determine a geographic location of the button and a time of button activation, the event tagging manager further configured to create an event record including the time of button activation and the geographic location at the time of button activation, the mobile device further including an annotation manager configured to access the event record, and allow user-annotation of the event record.

19. The apparatus of claim 18, wherein the mobile device is further configured to share the annotated event record with a plurality of members of a social community.

20. The apparatus of claim 18, wherein the user-annotation of the event record occurs at a time subsequent to the event and at a geographic location different from the event location.
